(19) United States
(12) Patent Application Publication
(10) Pub. No.: US 2007/0282689 A1
(43) Pub. Date: Dec. 6, 2007

(54) Method and apparatus for modeling and executing deferred award instrument plan

(76) Inventor: Keith Grosz, Chesterfield, MO (US)

Correspondence Address: Paul M. Denk, Ste.170, 763 S. Ballas Road, St. Louis, MO, 63141, US

(21) Appl. No.: 11/799,518

(22) Filed: May 2, 2007

Related U.S. Application Data
(60) Provisional application No. 60/797,593, filed on May 4, 2006.

(51) Int. Cl. G06Q 30/00

(52) U.S. Cl. 705/14

(57) ABSTRACT

The present invention is directed to the method and system of using a toolbar as a fundraiser and a way to raise funds for any charitable organization or religious organization, scholastic or any non-profit organization who needs money for different uses within their organizations. The organization sends a notice to their members or supporters that a fundraiser or method of raising funds will now be started (put in place) by having the members or supporters download a custom toolbar that meets the needs of the organization and the end users (members-supporters-followers), the toolbar will be downloaded on the members or supporters own computer. The end user can now do searches from the search engine located on the toolbar, as a way to raise money for charitable purpose and to facilitate the users ability to do searches. The toolbar will also be used to raise additional money for the organization by selling goods and services and trips. The end user will receive a message that will appear on the toolbar and read by the members and supporters offering some type of goods and or services or trips or any message the organization wants to say. The members and supporters will have the benefit of the toolbar all dollars raised will be considered a fundraiser or source of funds. There is also an opportunity for companies to place ads on the toolbar, and also provides an opportunity to place ads on the landing page, which will also contribute to the organization as a source of funds and fundraiser. The toolbar will have messages and information that will help the end user feel connected and up-dated. The more the end user feels connected to the organization and the more times the end users see's the organizations name and information the more money the end user will want to donate to the organization.

### CROSS REFERENCE TO RELATED APPLICATION

This non-provisional application claims priority to provisional application Ser. No. 60/797,593 filed on May 4, 2006, commonly owned by the same inventor.

### FIELD OF INVENTION

The present invention relates to using a toolbar as a method and system for raising money as a fundraiser for any organization or charity that has a need for money. Money will be raised by receiving fees for doing a search using the search engine that is part of the toolbar, as well as selling goods and services through links on the toolbar, as well as charging for advertising on the toolbar, in addition to selling advertising on the search landing page, and in addition, receiving direct donations using a donation link located directly on the toolbar.

### BACKGROUND OF INVENTION

Competition within organizations and charities to raise money for their own causes has increased. Organizations and charities have a desire to provide value in return of receiving dollars. Providing something of value will enhance loyalty between the organizations and the people who care enough to donate money. Providing something of value also shows the end user that the organization cares about them. It is also very important to stay connected and to communicate. The idea of having the need to raise money and to have fundraisers as well as enhancing loyalty and staying connected and the desire to communicate as well as showing you care; is a major reason the toolbar is a perfect fit to accomplish all that has been mentioned. I took the toolbar and the need for organizations to raise money and the increased competition for fundraisers and put them together. There is no one using the toolbar as a way to raise money for non-profit organizations, charities, religious organizations and scholastic organizations.

The organization has the ability to change a message on the toolbar in real time and to customize features that meet the organizations communication and fundraising needs. The ability to change a message within the toolbar that will then show up to anyone who has the toolbar downloaded is one of the keys to the ability to raise money. Messages can be put in the toolbar that will allow the organization to sell goods and services to raise more money, as well as suggest other fundraising ideas. Also, within the toolbar is the ability to include advertisers who may want to show an ad or sell something to the target market, also giving the organization a way to raise money. One of the key fundraising drivers is the fees from searches completed using the search engine located on the toolbar. This gives the end user the ability to donate money to a charity without writing a check, just by doing a search, the same type of search they would do anyway. But now, through the use of this invention, they will do the same search located upon the toolbar for the company, or organization, and at the same time aid in raising money for any select charity, or the like.

The business method and system of using the toolbar as a fundraiser, and a way to raise money, is something that meets the needs of an organization and charity that needs money for the many reasons organizations and charities need money. The toolbar has many uses and is used in many different ways. There are many different ways to raise money and create a fundraiser. Using the toolbar as a way to raise money and as a fundraiser is a business method that creates a benefit for the organizations as well as the end users. Everyone wins and receives something of value. The organization receives money, the end user receives a toolbar and can now receive up-dates, communication, as well as buy goods and services, as well as have easy access to the organizations web page, and have a search engine all at a convenient place on their computer.

### SUMMARY OF THE INVENTION

The present invention provides a method and system that helps solve a need to raise money as a fundraiser for non-profit organizations and charities, scholastic, as well as other organizations. The invention does this by using a toolbar as a source of generating dollars by offering the toolbar to members or supporters of the organizations to download the toolbar on to their own computer. Also the toolbar will be used to sell goods and services, also the tool bar will have space for advertising, as will the search engine located on the toolbar. All of which is used to raise money and to be used as a fundraiser. The end users are supporting a good cause or a charity/organization they are passionate about, and in return receive messages and information that will make them feel connected and a part of the organization in an even bigger way then before they had the toolbar. The method and system is directly as follows; Using the toolbar as a way to raise money by doing a search on the search engine located directly on the toolbar. Also the ability to sell space on the toolbar and the search engine landing page to advertisers, and to sell goods and services by using a link on the toolbar or the space on the toolbar that is dedicated for messages; the message at times will be used to sell goods and services which will in turn help raise money for the organization, and also the ability to have a link for donations to be made directly from the toolbar. Everyone wins, the end user has a toolbar on their computer with the logo and link of the organization they support and are passionate toward, they also receive communication and information that may be helpful or inspirational or just a way to stay up-dated, as well as see advertising that may help them as well with items or services they need. Also by having the toolbar they will have easy access to buy goods and services from the organization that are sold through the toolbar. The organization and charity and non-profit benefits because they now raise dollars needed through this fundraiser as well as have an opportunity to sell more goods and services, as well as charge for advertising if they so desire. Also they benefit because the toolbar stays on the computer of their supporters and keeps them connected with their supporters which in turn enhances loyalty as well as shows a sense of caring. The organization can communicate information and up-dates or any other communication they feel they want their supporters to see; such as a daily prayer or inspirational sayings by using the message section of the toolbar. This truly is a win-win situation and a business method that serves a purpose as a fundraiser and a way to raise money and in return give something of value.

It is the principal object of this invention is to provide a means for generating fundraising for any charitable or other organization through the use of the toolbar normally provided upon the computer screen.

Another object of this invention is to provide means for generating income, in addition to creating charitable contributions, through the use of a toolbar for a computer.

These and other objects may become more apparent to those skilled in the art upon review of this summary of the invention as provide herein, and upon undertaking a study of the description of its preferred embodiment.

### BRIEF DESCRIPTION OF THE DRAWINGS

FIG. 1 is a flow diagram showing all the steps needed to use a toolbar as a fundraiser;

FIG. 2 is a block diagram showing different ways the toolbar will be used to raise money as a fundraiser;

FIG. 3 is a block diagram showing examples of features a customized toolbar can have;

FIG. 4 is a flow diagram showing the steps needed to download a toolbar by the end user.; and

FIG. 5 is a block diagram showing reports an organization will receive to track dollars raised as a fundraiser and other helpful information.

### DESCRIPTION OF THE PREFERRED EMBODIMENT

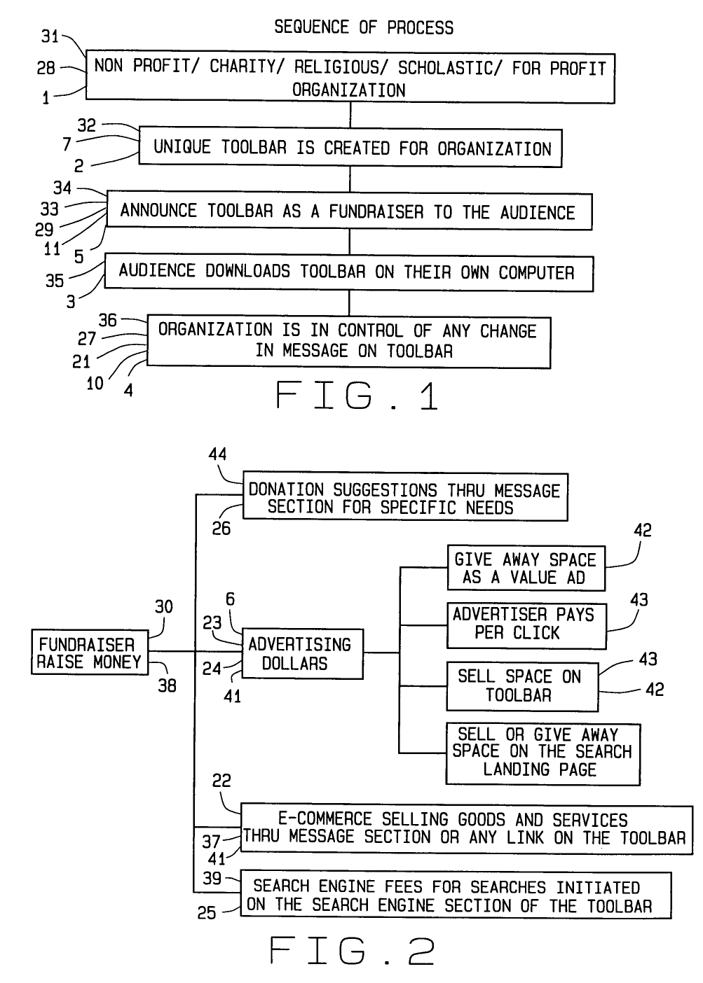

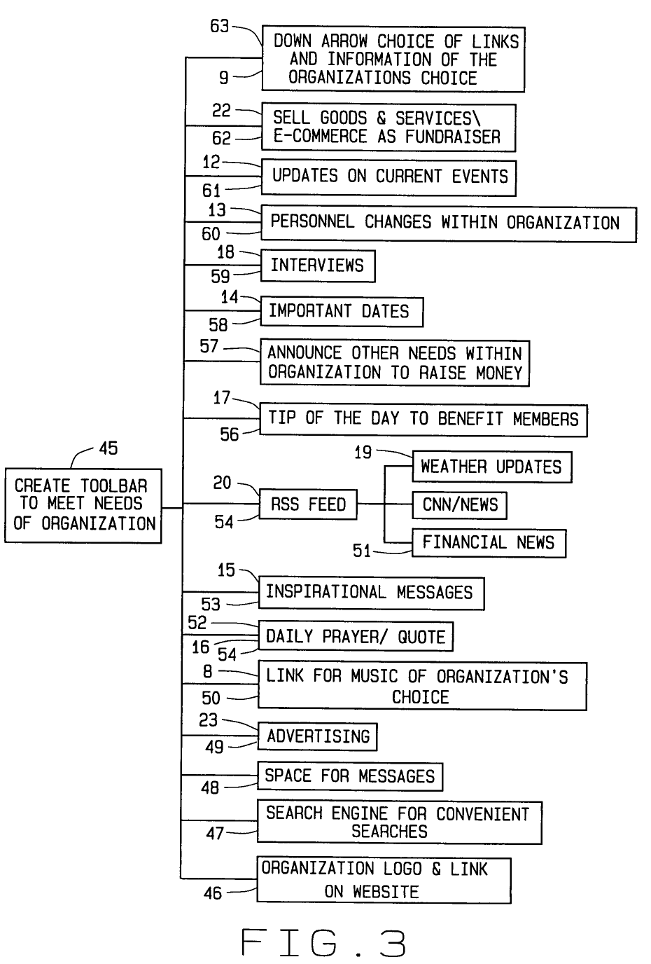

The present invention provides a method and system for using a toolbar as a fundraiser as a way to raise money for non-profit organizations, charities, and religious organizations 1 and 5. See FIG. 1. A customized toolbar 2 is created for every organization with the following standard features: A space on the toolbar for the organizations logo and link to the web page of the organization. This space on the toolbar will be a convenient way for the end user to go into the site, as at 3, of the organization if they choose to see more in depth information on the organization. There will also be a space on the toolbar for a search engine site, so that the end user can search on any subject they desire by typing in a key word, and then let the search engine site find the results. This space on the toolbar will be a convenient way for the end user to do a search without going to a separate browser. There will also be a space on the toolbar for a message the organization controls and can be changed in real time, as at 4. The message can be changed by someone in the organization who has the authorization to change the message on the toolbar; the message will then be displayed on every toolbar within the system and will be displayed in real time, without the use of an engineer to make any of the changes. There will also be a space on the toolbar and the search engine landing page for advertisements by any company who the organization feels the end users would benefit by seeing advertisement, FIG. 2 as at 6. Each organization can customize the toolbar with features within the toolbar, FIG. 1, as at 7. Examples of customized features may be a space for a music link to play music the organization feels the end user would want to hear, FIG. 3, as at 8. The end user would then click on the link on the toolbar that has music then listen while doing whatever else they were already doing on the computer. Other potential features an organization may choose to use as a way to customize the toolbar may be using a down arrow showing additional links or information that may be of interest to the end user, FIG. 3, as at 9.

The idea of the message section of the toolbar is the heart and soul of the toolbar, it is a way to communicate and keep the end user up-dated with information that the organization feels would be beneficial to the end user, FIG. 1, as at 10. In most cases the end user will be supporters of the organization or members or someone passionate about what the organization stands for, FIG. 1, as at 11. Examples of the kind of information within the message section of the toolbar could be; up-dates, FIG. 3, as at 12, personnel changes, FIG. 3, as at 13, important dates, FIG. 3, as at 14, inspirational message or sayings, FIG. 3, as at 15, daily prayers, daily joke, FIG. 3, as at 16, daily tip of the day in whatever area that may be of interest to the end user, FIG. 3, as at 17, financial news, business news, news in general, sports scores, interviews, FIG. 3, as at 18, weather up-dates, FIG. 3, as at 19, the message could also be an RSS feed which would then automatically be up-dated as the feed is up-dated, FIG. 3, as at 20. Basically the message section will have information that will be of interest to the end user, FIG. 1, as at 21. The information will help keep both the end user and the organization connected and loyal as well as help make the end user have a better day from the information they may see on the toolbar. The message section will also be a way to raise more money by allowing the organization to sell goods and services for sale, which in turn is a convenient way for the end user to buy goods and service of interest to them, and in turn allows the organization to raise more dollars, FIG. 2, as at 22. The space for advertisers will also be a source of revenue for the organization which in turn is another way to raise money for the organization, FIG. 2, as at 23. The advertisers will pay for space on the toolbar, as well as pay for clicks as someone looks at the link of the advertising company, FIG. 2, as at 24. Also, the search engine fees will be used, as noted at FIG. 2, at 25, as a fundraiser as well as for use for receiving donations directly from a link on the toolbar. See also FIG. 2, as at 26.

The toolbar stays on the computer screen as long as the end user is using the internet. The toolbar does not disappear when the end user changes browser it stays in the same spot on the computer screen. The end user can choose where on the screen they want the toolbar to appear. Also the end user can choose to erase the toolbar from the screen if they would rather not look at it anymore. The message section of the toolbar can be changed in real time by using a pass code the organization receives and then the organization will assign someone to be in charge of changing the message, FIG. 1, as at 27. There will be checks and balance within the organization to make sure only the message they want sent is sent.

The heart and soul of the invention and the reason for the invention is the business method and system of using the toolbar as a fundraiser or as a way to raise money for a non-profit organization, a religious organization, scholastic and any charity. The organization will offer the toolbar to its members, supporters, followers as a way of raising money and a fundraiser, FIG. 1, as at 28. The end user's are donating money to the organization they support and in return they will receive something of value; the toolbar. There is no overhead expense or additional personnel needed by the organization or no up-front cost to the organization other than any cost associated with getting the word to the supporters, followers, members that this offer as a fundraiser is being offered, as in FIG. 1, as at 29. The toolbar used as a fundraiser or as a way to raise money is a win-win for all parties, FIG. 2 as at 30. The charities, religious, scholastic organizations and non-profit organizations, receive money they need and the end user receives a toolbar that will provide them with useful information.

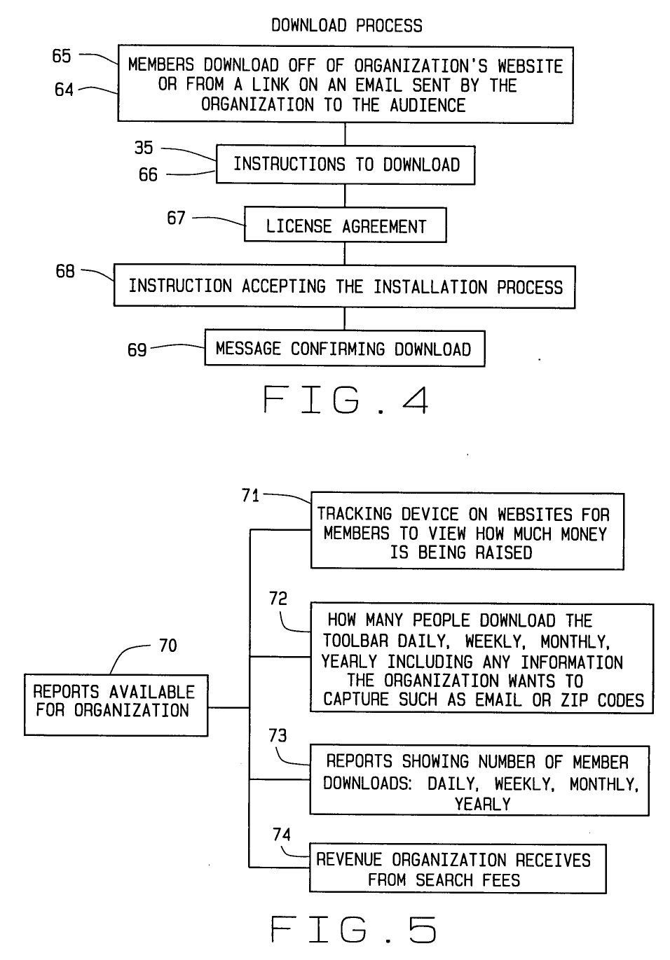

FIG. 1 is a flow chart showing the steps needed to accomplish the business method of using a toolbar as a fundraiser and a way to raise money for organizations that need money. The first step is to identify the target market; which is any non profit organization, or charity or religious, scholastic organization or corporation, as at 31. Basically any organization who needs money, can use a fundraiser as a way to raise funds to meet financial needs they may have, and who has a need to communicate with their audience. After contacting the organizations the next step in the flow chart is to create a unique toolbar for that specific organization to meet their specific needs, as at 32. Every organization will have a toolbar created with features they feel will benefit the end user (the members-supporters-followers). The next step is to then announce the idea of a fundraiser using the toolbar to their members-supporters-followers, as at 33. This can be accomplished through a newsletter, or web page, or email blast, or a written letter, or through announcements at events. As a bottom line, the organization will get the word out that this opportunity of using a toolbar as a fundraiser will now be available, as at 34. The next step on the flow chart is to have a system for the end users to download the toolbar onto their own computers, as at 35. This will be a very easy and convenient system the end user can follow and will take less then 2 minutes to download the toolbar. Instructions will be provided to the end user as well as the opportunity for support if they have any problems or delays, FIG. 4, as at 35. The next step on the flow chart is the ability for the organization to change messages on the toolbar, as at, 36. This is another way to raise money as a fundraiser as well as a way to send messages and information the end user will feel is beneficial and useful. The organization can sell goods and services through the message section of the toolbar, FIG. 2, as at 37. The organization will assign one or two people to be in charge of changing the message. There will be a system for checks and balances so that only approved information can be sent to the toolbar. There is no need for an engineer to change the message and no additional expenses needed.

FIG. 2 is a block diagram of the different ways to raise money using the business method of a toolbar as a fundraiser, as at 38. This can be noted at 38, in said FIG. 2. The first way to raise money is from search engine fees from searches initiated from the search engine located on the toolbar, as can be noted at 39. The next way to raise money using a toolbar as a fundraiser is by selling goods and services directly from the toolbar, as at 40. A message will appear on the toolbar announcing what ever the organization wants to sell, or a direct link on the toolbar to a store of some kind. The dollars from those sales will be used as a fundraiser over and above any cost of the goods they are selling. The organization receives 100% of those funds from any sales from the toolbar. The next way to raise money is from selling space to advertisers on the toolbar, as noted at 41. The organization will have the option to give away space as a value added feature, or to sell space to whoever they think would be a good fit for their organization, and end uses, as at 42. The advertisers will pay for space on the toolbar, or pay every time an end users clicks on their site within the toolbar, as at 43. There is an additional way to use the toolbar as a fundraiser. The organization can announce through the message section of the toolbar the opportunity to donate dollars toward different needs that may come up through out the year, as at 44. The organization would receive 100% of those dollars raised for the needs they are targeting.

FIG. 3 is a block diagram showing many of the creative ways a toolbar can be customized to meet the needs of the organization and end users, as at 45. The first space will be the organizations logo and link to their web page, as at 46. This will be a convenient and easy way for the end user to go into the web page of the organization for more in-depth information. Also on the toolbar will be a space for a search engine site, as at 47. This will be a convenient and easy way for the end user to search any topic they may have a desire to search. On all toolbars the next space will be the section for the messages the organization will be sending on the toolbar to the end users, as at 48. These messages will be controlled by the organization and received by the end user in real time. There is no need for an engineer to make these changes on the message section, it can be controlled by anyone the organization chooses to be in charge of changing the messages. There will also be space on the toolbar for advertisers if the organization chooses to have advertisers, as at 49. The organization will be in control deciding what companies can advertise on their toolbar. The following is a sample of ideas that can also appear on the toolbar if the organization chooses to use any of the following ideas: Link for music that can be played which will be the choice of the end user to play or not play the music, as at 56, a daily prayer, as at 51, quote, as at 52, inspirational message, as at 53, scores, RSS feed that may have weather up-dates or CNN news, as at 54, or financial news, as at 55, a tip of the day can appear on the toolbar featuring a topic of interest to both the organization and the end-users, as at 56, announcements of other needs the organization has and needs money for, as at 57, important dates, as at 58, interviews, as at 59, personnel changes within the organization, as at 60, up-dates on current events, as at 61, sell goods and services/E-Commerce, as at 62, and there can be a down arrow on the toolbar leading to other links such as sermons or additional prayers or other events with more in-depth information, as at 63.

FIG. 4 is a flow chart showing the steps needed for the end user (members-followers-supporters) to download the toolbar on to their own computer, as at 64. The toolbar should appear on the organizations web page unless the organization would rather the end user download off of my web page, as at 65. The end users click on the toolbar then they will see instructions on what the following steps are to complete the download, as at 66. Then they will see a license agreement they will need to accept to then move to the next step, as at 67. The next step are a series of two to three boxes, that show different stages of the installation, as at 68. The next step is a message they will receive showing the process is completed and will confirm the fact that they can now start enjoying the benefits of the toolbar, as at 69.

FIG. 5 is a block diagram showing different reports the organization will receive that will benefit them as they track the dollars raised using the toolbar as a fundraiser, as at 70. The first devise is a way for the end users to track the money being raised by seeing a measurement tool on the organizations web page showing money paid in to date, as at 71. Then there will be a report generated for the organization showing how many people download the toolbar on a daily-weekly-monthly-yearly basis, as at 72. The next report will be a document showing number of end users who have downloaded the toolbar including email and zip code information or any information the organization wants to capture on a daily-weekly-monthly-yearly basis. Then their will be a report for the organization to see showing search engine revenue, as at 74.

Variations or modifications to the subject matter of this invention may occur to those skilled in the art upon review of the invention as described herein. Such variations, if within the spirit of this development, are intended to be encompassed within the scope of the invention as described. The specific description of the invention, and its depiction in the drawings, is set forth for illustrative purposes only.

Therefore, what is claimed of this invention is:

1. A method incorporating software for using a toolbar for a computer as for a company or a fundraiser as a means to raise money for a religious, scholastic, or medical organization, charity, and other non-profit organizations;
identifying an organization that desires to collect money and establish a fundraiser using said toolbar to raise funds to benefit charities through the organization;
creating said toolbar that meets the needs of the organization and also fits their charitable objectives through the provision of displayed information selected by the organization for use upon the toolbar and that would then be of a benefit to their followers, supporters, and members;
creating through said software a system so that the end user can download the toolbar in a convenient manner to receive the benefits of said toolbar;
creating through said software a system whereby the end user through use of a search engine downloads from the toolbar, and through said search generates a fee as a way to raise funds for the charity of choice of the organization; and
creating through said software a system so that the organization can vary the toolbar message, and what messages shall appear on the toolbar of the end users to vary the downloadable information which when utilized generates funds for the organization's charities.

2. The method incorporating software of claim 1, and further comprising:
creating within the message section of the toolbar for a computer the ability of the organization to sell goods and services and generate income from the toolbar for charitable purposes.

3. The method incorporating software as defined in claim 1, and further comprising:
incorporating within the message section of the computer toolbar the opportunity of the organization to display its participation in fundraising for charitable purposes and the method to raise contributions through contributors usage of the organization's toolbar, through the sale of goods and services.

4. The method incorporating software as set forth in claim 1, and further comprising:
providing means during usage of the organization's toolbar to prevent outsiders form sending unapproved messages through the organization requiring at least one party to approve any text message to be sent to any other toolbar user.

5. The method incorporating software of claim 1, and further comprising: the provision of space upon the computer toolbar and the landing page of the search engine dedicated to advertisers whereby advertisers pay to promote their products and services upon the organizations toolbar as a method serving as a fundraiser for the organization to give to its select charities.

6. The method incorporating software as set forth in claim 1, and further comprising:
the provision of space upon the organization's toolbar to provide a search engine to facilitate usage by the end user for doing a search through the organization's toolbar, for generating fees as a fundraiser.

7. The method incorporating software as set forth in claim 1, and further comprising:
the organization's toolbar having space to provide for display of the organization logo, and further incorporating a link to the organization web page to facilitate access to the web page by the end user to furnish more information regarding the activities of the organization.

8. The method incorporating software as set forth in claim 5 and further comprising:
the advertisers may pay for the space they use on the toolbar and the search engine landing page as well as may pay per click each time the user goes from the toolbar directly to a site by clicking on the advertiser's space on the toolbar, all as ways the organization can raise money for use as a fundraiser.

9. The method incorporating software as set forth in claim 8, and further comprising:
the provision of space upon the toolbar or landing page for advertisers, with the organizations selecting those spaces upon its toolbar for its selected advertisers.

10. The method incorporated software as set forth in claim 8, and further comprising:
the software providing the organization with the ability to select and edit the type of advertising to be conducted by subscribers upon determining what kind of advertising they want on the toolbar.

11. The method incorporating software as set forth in claim 8 wherein the organization may give away space on the toolbar as an incentive to its advertisers and corporate sponsors as a way to further raise funds for charitable purposes.
